(19) United States
(12) Patent Application Publication
(10) Pub. No.: US 2026/0006484 A1
(43) Pub. Date: Jan. 1, 2026

(54) STATION, ACCESS POINT AND METHOD FOR LOW LATENCY TRAFFIC IN WIRELESS NETWORKS

(71) Applicant: InterDigital Patent Holdings, Inc., Wilmington, DE (US)

(72) Inventors: Xiaofei Wang, North Caldwell, NJ (US); Hanqing Lou, Syosset, NY (US)

(21) Appl. No.: 18/757,095

(22) Filed: Jun. 27, 2024

(51) Int. Cl. H04W 28/02; H04W 88/10

(52) U.S. Cl. CPC H04W 28/0236; H04W 88/10

(57) ABSTRACT

Methods and device are disclosed for station (STA) multi-link device (MLD) or non-access point (Non-AP) STA affiliated with a first STA and second STA. The first STA receives from a first access point (AP) affiliated with an AP MLD, on a first wireless link, a frame indicating traffic restriction information associated the first wireless link and a second wireless link. The second wireless link is configured for communication between a second STA affiliated with the STA MLD and a second AP affiliated with the AP MLD. Data having a low latency requirement are transmitted on at least one or more of the first and the second wireless links based on the received traffic restriction information. Corresponding methods and devices for an AP MLD are also disclosed.

### TECHNICAL FIELD

The present disclosure is generally directed to the fields of communications, software and encoding, including methods, architectures, apparatuses, and systems directed to wireless networks, including notably nodes (e.g. access points, user equipment, wireless devices) have low latency requirements.

### BACKGROUND

A Wireless Local Area Network (WLAN) in Infrastructure Basic Service Set (BSS) mode has an Access Point (AP) for the BSS and one or more stations (STAs) associated with the AP. An example of WLAN Medium Access Control (MAC and Physical Layer (PHY) is disclosed in IEEE Std 802.11™-2020 specifications. Some additional specifications are defined in IEEE P802.11be™-D6.0 as published in May 2024. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA. Such traffic between STAs within a BSS is really peer-to-peer traffic. Such peer-to-peer traffic may also be sent directly between the source and destination STAs with a direct link setup (DLS) using an 802.11e DLS or an 802.11z tunneled DLS (TDLS). A WLAN using an Independent BSS (IBSS) mode has no AP, and/or STAs, communicating directly with each other. This mode of communication is referred to as an “ad-hoc” mode of communication.

Using the 802.11ac infrastructure mode of operation, the AP may transmit a beacon on a fixed channel, usually the primary channel. This channel may be 20 MHz wide, and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the occupancy or vacancy of the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to 802.11n described above. A160 MHz channel may be formed either by combining 8 contiguous 20 MHz channels, or by combining two non-contiguous 80 MHz channels, this may also be referred to as an 80+80 configuration. For the 80+80 configuration, at the transmitter, the data, after channel encoding, is passed through a segment parser that divides it into two streams. IFFT and time domain processing are done on each stream separately. The streams are then mapped on to the two channels, and the data is transmitted. At the receiver, this mechanism is reversed, and the combined data is sent to the MAC.

Sub 1 GHz modes of operation are supported by 802.11af, and 802.11ah, For these specifications the channel operating bandwidths, and carriers, are reduced relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. A possible use case for 802.11ah is support for Meter Type Control (MTC) devices in a macro coverage area. MTC devices may have limited capabilities including only support for limited bandwidths, but also include a requirement for a very long battery life.

WLAN systems which support multiple channels, and channel widths, such as 802.11n, 802.11ac, 802.11af, and 802.11ah, include a channel which is designated as the primary channel. The primary channel may, but not necessarily, have a bandwidth equal to the largest common operating bandwidth supported by all STAs in the BSS. The bandwidth of the primary channel is therefore limited by the STA, of all STAs in operating in a BSS, which supports the smallest bandwidth operating mode. In the example of 802.11ah, the primary channel may be 1 MHz wide if there are STAs (e.g. MTC type devices) that only support a 1 MHz mode even if the AP, and other STAs in the BSS, may support a 2 MHz, 4 MHZ, 8 MHz, 16 MHz, or other channel bandwidth operating modes. All carrier sensing, and NAV settings, depend on the status of the primary channel; i.e., if the primary channel is busy, for example, due to a STA supporting only a 1 MHz operating mode is transmitting to the AP, then the entire available frequency bands are considered busy even though majority of it stays idle and available.

In the United States, the available frequency bands which may be used by 802.11ah are from 902 MHz to 928 MHz. In Korea it is from 917.5 MHz to 923.5 MHz; and in Japan, it is from 916.5 MHz to 927.5 MHz. The total bandwidth available for 802.11ah is 6 MHz to 26 MHz depending on the country code.

According to existing channel access procedure, we may consider basic channel access. IEEE 802.11 STAs usually perform random backoff procedure before transmitting for each contention period.

When a STA determines that the medium is idle and a frame is queued for transmission, and wireless medium remains idle for a period of a DIFS, or an EIFS from the end of the immediately preceding medium-busy event, it may invoke a random backoff procedure if the backoff counter has a non-zero value. The STA may start transmitting if the wireless medium remains idle after the backoff counter reaches 0. The backoff counter is set to an integer value chosen randomly with a uniform distribution between 0 to CW, where CW is an integer value between aCWmin and aCWmax. aCWmin and aCWmax are values set by the AP. The system will set the initial value of CW as aCWmin. CW is doubled when a collision or transmission failure occurs. The CW value is capped by aCWmax. The CW is reset to aCWmin after every successful transmission.

When the backoff procedure is invoked, the backoff counter initially is set to an integer value chosen randomly with a uniform distribution taking values in the range 0 to CW[AC]. AC here is an index corresponding to an access category. If no medium activity is indicated for the duration of a particular backoff slot, then the backoff procedure shall decrement its backoff counter.

An IEEE 802.11 Ultra High Reliability (UHR) Study Group was formed in September 2022. UHR is considered as the next major revision to IEEE 802.11 standards following 802.11be, which is currently in the Working Group Letter Ballot Stage. UHR is formed to explore the possibility to improve reliability, support low latency traffic and further increase peak throughput and improve efficiency of the IEEE 802.11 networks.

To support low latency traffic transmission, several contributions have been proposed to allow STAs with low latency traffic to transmit a signal without back off in a contention period. The signal is referred as a Defer Signal in some contributions (for example, document referred as 11-23/2126 entitled “Low Latency channel access”). After the transmission of the Defer Signal, the STAs without low latency traffic may hold their contention and wait for next transmission opportunity. The STAs which transmitted the Defer Signal may start a backoff. The purpose of the backoff is to reduce the chance of collision when more than one STAs transmit the Defer Signal concurrently.

Other contributions have been proposed including (for example, document referred as 11-24/00311r0 and entitled “deterministic backoff”) in which STAs with low latency traffic may apply deterministic backoff and using Interruptions per TXOP parameters to self-organize into a backoff order that is more deterministic than the traditional EDCA channel access.

Other approaches to address low latency channel access including preemptions. For example, in document referred as 11-24/168r0-TXPO Preemption in 11bn″, proposals have been made to have STAs with low latency traffic gain early channel access during other STAs' TXOPs to ensure sufficient delays.

### SUMMARY

One or more of the foregoing issues or needs may be addressed by aspects of the embodiments disclosed herein.

In certain aspects, a station (STA) multi-link device (MLD) comprises: a processor configured to operate a first station (STA) affiliated with the STA MLD and a second STA affiliated with the STA MLD; a receiver, coupled to the processor, configured to receive, by the first STA from a first access point (AP) affiliated with an AP MLD, on a first wireless link, a frame indicating traffic restriction information associated the first wireless link and a second wireless link, wherein the second wireless link is configured for communication between the second STA and a second AP affiliated with the AP MLD; and a transmitter, coupled to the processor, configured to transmit data having a low latency requirement on at least one or more of the first and the second wireless links based on the received traffic restriction information.

In certain aspects, a method for use in a station (STA) multi-link device (MLD), comprises: receiving, by a first STA affiliated with the STA MLD from a first access point (AP) affiliated with an AP MLD, on a first wireless link, a frame indicating traffic restriction information associated the first wireless link and a second wireless link, wherein the second wireless link is configured for communication between a second STA affiliated with the STA MLD and a second AP affiliated with the AP MLD; and transmitting data having a low latency requirement on at least one or more of the first and the second wireless links based on the received traffic restriction information.

In certain aspects, the low latency data has a lower latency requirement relative to other data traffic.

In certain aspects, the frame is at least one of a control frame, a management frame, or a data frame.

In certain aspects, the traffic restriction information comprises a low latency link bitmap subfield that indicates low latency traffic permission associated with the first and the second wireless links.

In certain aspects, the traffic restriction information comprises a first link traffic information and a second link traffic information, the first link traffic information indicating an allowed traffic type on the first wireless link and the second link traffic information indicating an allowed traffic type on the second wireless link.

In certain aspects, the traffic restriction information comprises a traffic restriction information presence indicator within a multi-link control field of a multi-link element.

In certain aspects, the traffic restriction information comprises a first allowed traffic type within a first station sub-element of a multi-link element corresponding to the first STA and a second allowed traffic type within a second station sub-element of the multi-link element corresponding to the second STA.

In certain aspects, an access point (AP) multi-link device (MLD) comprises: a processor configured to operate a first AP affiliated with the AP MLD and a second AP affiliated with the AP MLD; a transmitter, coupled to the processor, configured to transmit, by the first AP to a first station (STA) affiliated with a STA MLD, on a first wireless link, a frame indicating traffic restriction information associated the first wireless link and a second wireless link, wherein the second wireless link is configured for communication between a second STA affiliated with the STA MLD and the second AP; and a receiver, coupled to the processor, configured to receive data having a low latency requirement on at least one or more of the first and the second wireless links based on the received traffic restriction information.

A method for use in an access point (AP) multi-link device (MLD), the method comprising: transmitting, by a first AP affiliated with the AP MLD to a first station (STA) affiliated with a STA MLD, on a first wireless link, a frame indicating traffic restriction information associated with the first wireless link and a second wireless link, wherein the second wireless link is configured for communication between a second STA affiliated with the STA MLD and a second AP affiliated with the AP MLD; and receiving data having a low latency requirement relative to other data traffic on at least one or more of the first and the second wireless links based on the received traffic restriction information.

Additional aspects are also disclosed.

One or more embodiments also provide a computer program comprising instructions which when executed by one or more processors cause the one or more processors to perform the methods according to any of the embodiments described herein.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2A is a diagram illustrating an example of a communication between an Access Point (AP) and a device of a Wireless Local Area Network (WLAN), in which one or more disclosed embodiments may be implemented;

FIG. 2B is a system diagram of an example wireless local area network (WLAN) in which one or more disclosed embodiments may be implemented;

FIGS. 2C and 2D illustrates methods implemented in device and AP of FIG. 2A;

FIG. 3 is a diagram illustrating an example of an access to a transmission channel for transmission of low latency traffic; and

FIGS. 4 to 7 are diagrams illustrating examples of frame including traffic restriction information.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

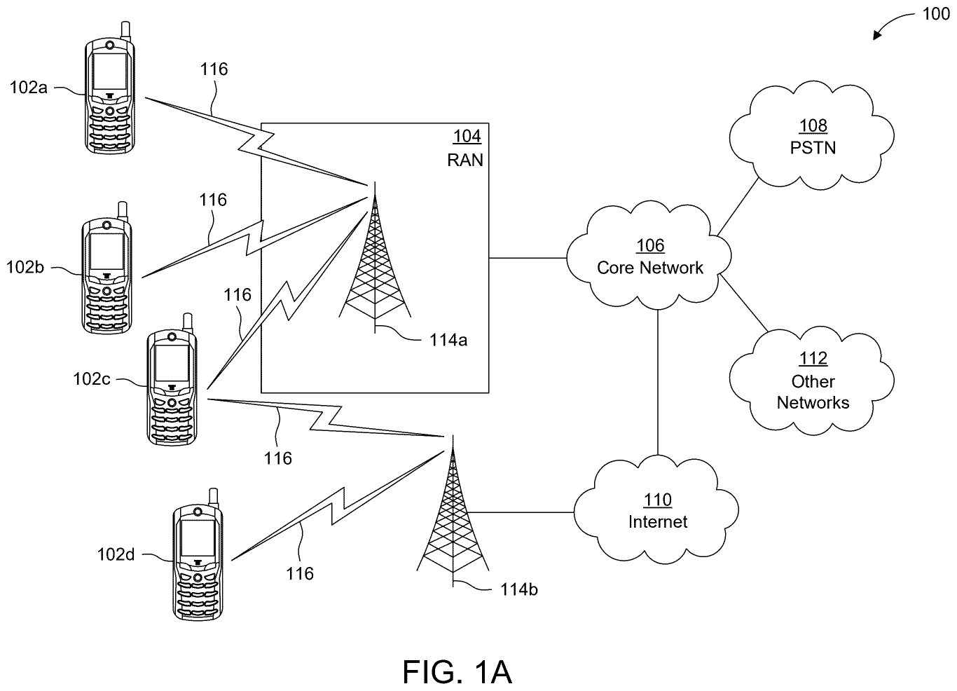

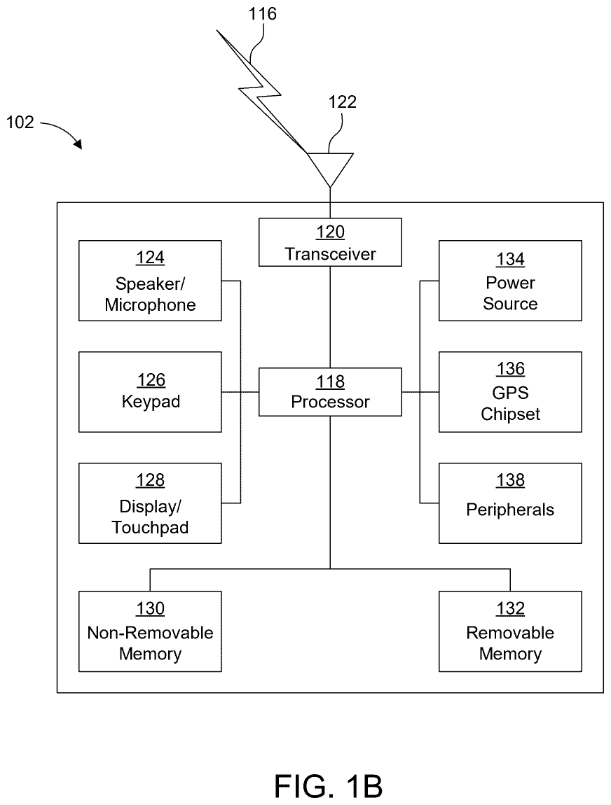

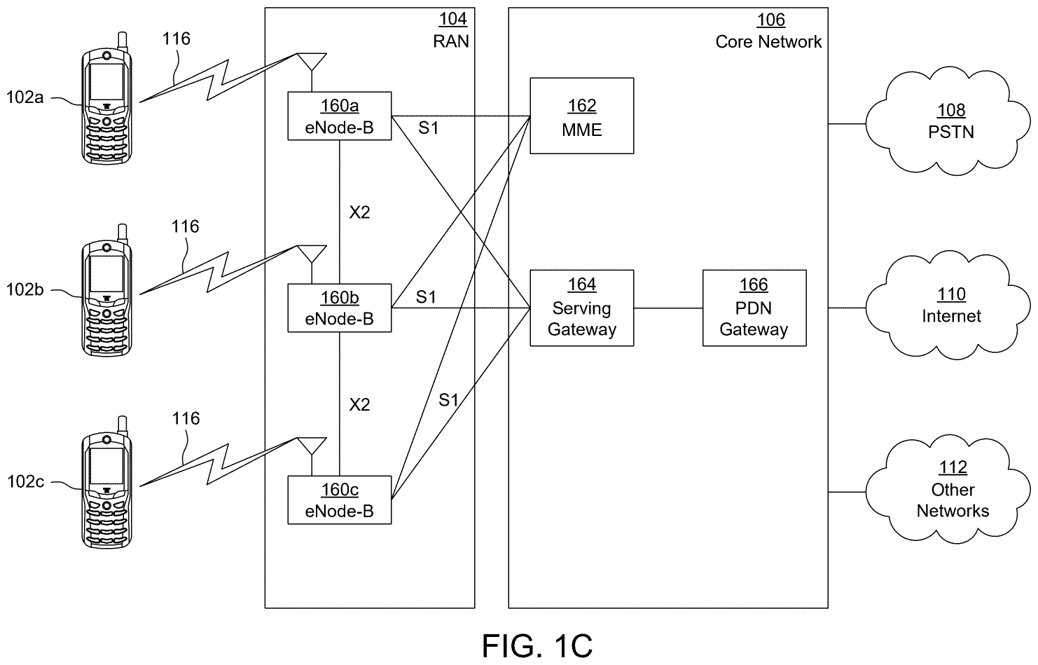

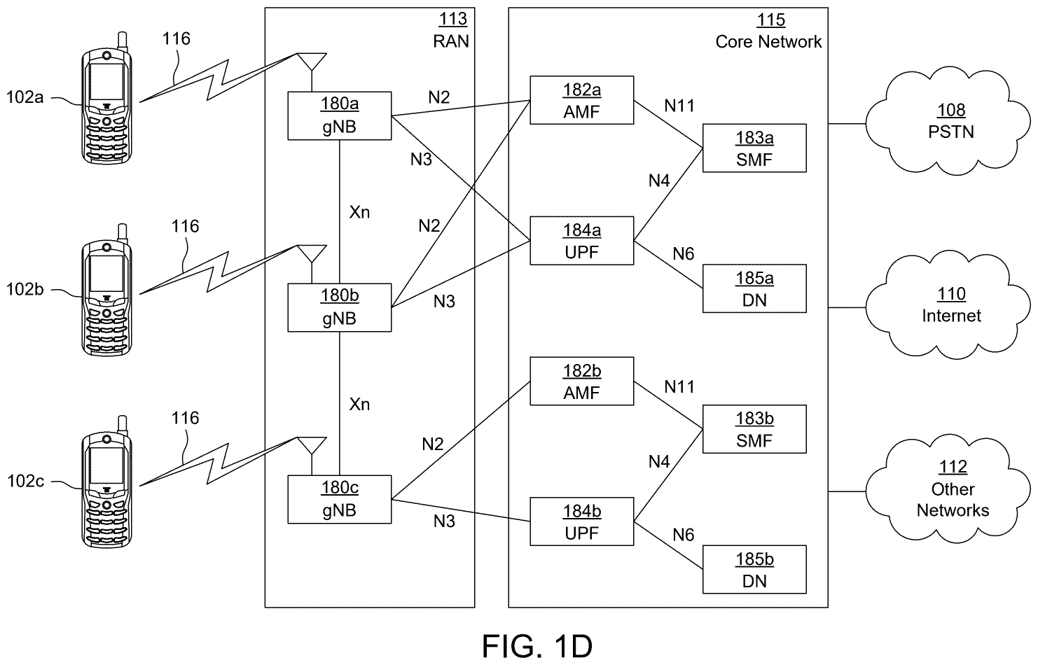

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between

STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHZ, and/or 160 MHz wide channels transmitted over a 5GHz frequency band using OFDMA. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHZ, 80 MHz, and/or 160 MHz wide channels capable of transmission over 2.4GHz, 5GHz, and 6GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and STA STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”.

In embodiments described herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’.

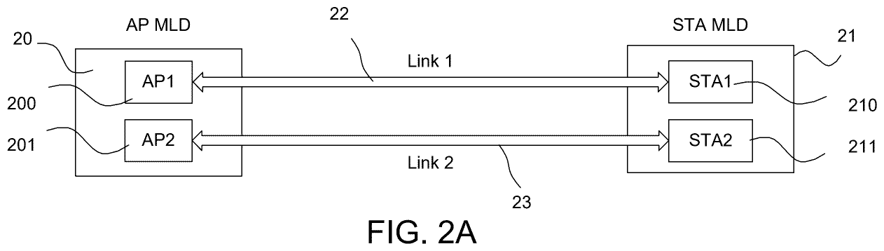

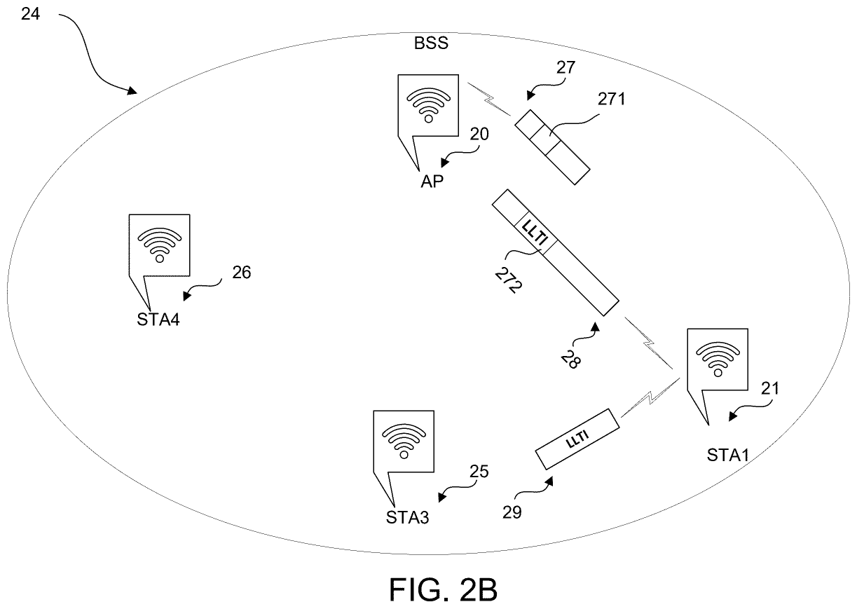

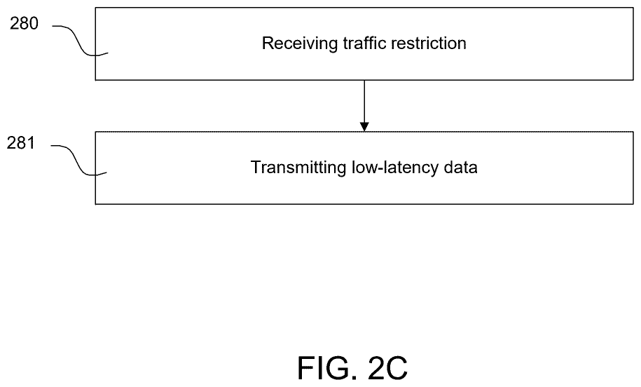

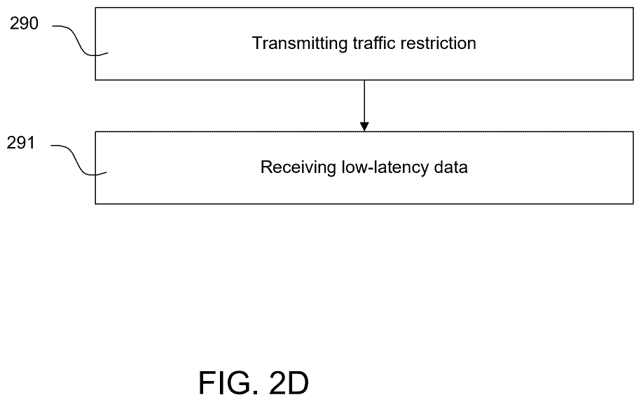

FIG. 2A shows an example of traffic between, a station (STA) multi-link device (MLD) 21 and an Access Point (AP) multi-link device (MLD) 20. In the present description of miscellaneous embodiments, drawings and claims, a STA MLD may be a non-AP MLD.

In an embodiment, the STA-MLD 21 comprises:
a processor configured to operate a first station (STA1) 210 affiliated with the STA MLD 21 and a second station (STA2) 211 affiliated with the STA MLD 21;
a receiver, coupled to the processor, configured to receive, by the first station 210, from a first access point (AP1) 200 affiliated with the AP MLD 20, on a first link 22, a frame indicating traffic restriction information associated the first link 22 and a second link 23, wherein the second link 23 is configured for communication between the second STA 211 and a second AP 201 affiliated with the AP MLD; and
a transmitter, coupled to the processor, configured to transmit data having a low latency requirement on at least one or more of the first 22 and the second 23 links based on the received traffic restriction information.

In an embodiment, the access point (AP) multi-link device (MLD) 20 comprises:
a processor configured to operate the first AP 200 affiliated with the AP MLD and the second AP 201 affiliated with the AP MLD 20;
a transmitter, coupled to the processor, configured to transmit, by the first AP to the first station (STA) 210 affiliated with the STA MLD 21, on the first link 22, a frame indicating traffic restriction information associated the first link 22 and a second link 23, wherein the second link is configured for communication between the second STA 211 affiliated with the STA MLD 21 and the second AP 201; and
a receiver, coupled to the processor, configured to receive data having a low latency requirement on at least one or more of the first and the second links based on the received traffic restriction information.

The frame indicating traffic restriction information may be at least one of a control frame, a management frame, or a data frame.

These embodiments may enable an efficient transmission from a STA-MLD to an AP MLD traffic having a low latency requirement. They also may enable a simple implementation of STA-MLD and AP MLD for low-latency traffic communication. Low latency data or communication has a lower latency requirement relative to other data traffic, which may have higher latency requirement or no latency requirement.

802.11bn group is targeting to provide support for low latency traffic. A number of medium access schemes have been proposed including Defer Signals, deterministic backoff and TXOP pre-emptions. These proposals include methods to allow stations with low latency traffic to act aggressively to obtain the wireless medium. Such aggressive behaviors need to be well managed by the network. The embodiments as disclosed in FIG. 2A to 2D may provide effective designs that can manage the aggressive medium access algorithms needed to provide low latency traffic the short delay that it needs while allowing sufficient fairness for other type of traffic and legacy stations.

Traffic with low-latency requirement may originate from many real time applications, which may have stringent requirements in terms of latency and jitter along with certain reliability constraints. Such traffic is referred to as latency sensitive traffic. Latency sensitive traffic may require packets to be delivered with predictable latency in terms of both its average and the worst case values over a wireless link.

Latency requirements may be defined as a latency threshold; low latency is lower than the threshold. This threshold may be defined as a specific value (e.g. 1 ms). Multiple values of threshold may be defined to enables different priorities among traffic having a low-latency requirement, the lower the threshold is, the higher the priority is. The MLD AP may take into account different priorities to enable access to the channel or links for a TxOP.

FIG. 2C is a diagram illustrating an example method for use in the station (STA) multi-link device (MLD) 21, the method comprising:
receiving, by a first STA 210 affiliated with the STA MLD from a first access point (AP) affiliated with the AP MLD 20, on a first link 22, a frame indicating traffic restriction information associated with the first link and a second link 23, wherein the second link is configured for communication between a second STA 211 affiliated with the STA MLD 21 and a second AP affiliated with the AP MLD 20; and
transmitting data having a low latency requirement on at least one or more of the first and the second links 22, 23 based on the received traffic restriction information.

FIG. 2D is a diagram illustrating an example method for use in an access point (AP) multi-link device (MLD), the method comprising:
transmitting, by a first AP affiliated with the AP MLD to a first station (STA) affiliated with a STA MLD, on a first link, a frame indicating traffic restriction information associated the first link and a second link, wherein the second link is configured for communication between a second STA affiliated with the STA MLD and a second AP affiliated with the AP MLD; and
receiving data having a low latency requirement relative to other data traffic on at least one or more of the first and the second links based on the received traffic restriction information.

In representative embodiments in accordance with the present disclosure, a MLD such as a STA MLD (e.g., non-AP MLD) or AP MLD may incorporate one or more transmitters and one or more receivers, or one or more transceivers that are couple to one or more processors. In some embodiments, the MLD may be controlled by a single processor or multiple processor, where one of the multiple processors controls one or more other processors.

### Low Latency Traffic Channel Access

According to existing channel access procedures, IEEE 802.11 stations (STAs) usually perform a random backoff procedure before transmitting for each contention period.

When a STA with a frame queued for transmission determines that the wireless medium is idle and the wireless medium remains idle for a period of a Distributed Inter-Frame Space (DIFS) or an Extended Inter-Frame Space (EIFS) from the end of the immediately preceding medium-busy event, the STA may invoke a random backoff procedure. The STA may start transmitting if the wireless medium remains idle after a backoff counter at the STA, which was set to a randomly chosen initial value, decrements down to 0. The backoff counter is set to an integer value chosen randomly with a uniform distribution between 0 to CW[AC], where CW is an integer value between aCWmin and aCWmax, and AC is an index corresponding to an access category (e.g., voice, video, best effort, background). aCWmin and aCWmax are values set by the AP. The STA (AP or non-AP) will set the initial value of CW to aCWmin. CW is doubled when a collision or transmission failure occurs but is capped by aCWmax. CW is reset to aCWmin after every successful transmission. If no medium activity is indicated for the duration of a particular backoff slot, then the backoff procedure shall decrement its backoff counter.

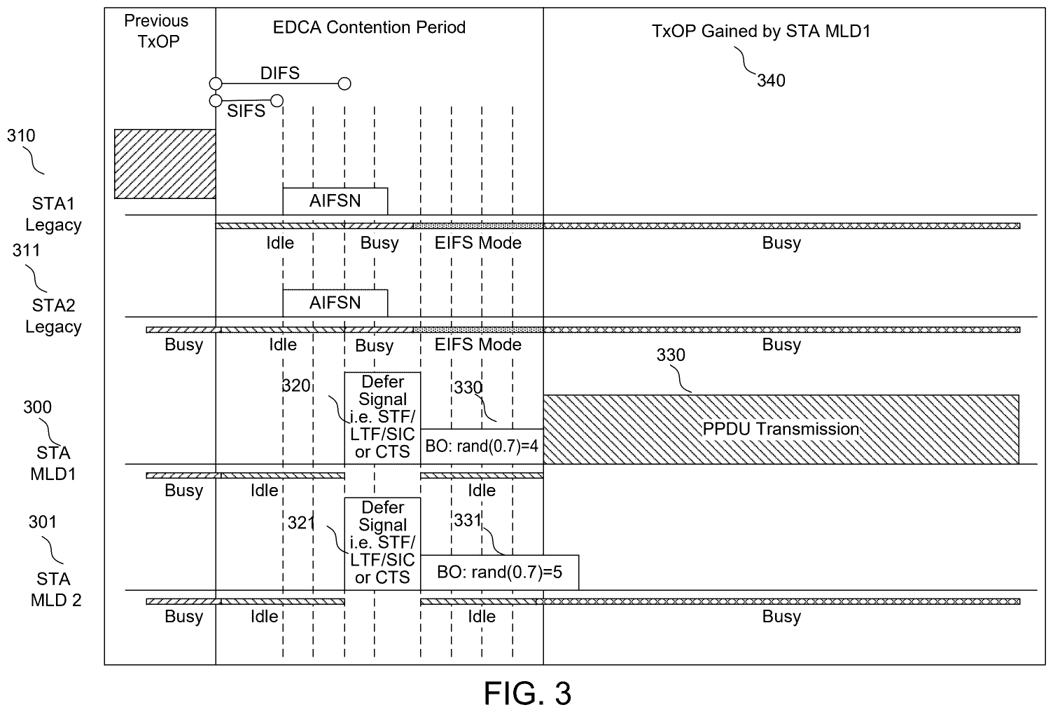

As illustrated in FIG. 3, to support low latency traffic transmission, one proposal is to allow STA MLD (e.g. STA MLD1 300 and STA-MLD2 310) with low latency traffic to transmit a Defer Signal (DS) 320, 321 without backoff in a contention period. After the reception of Defer Signal transmitted from one or more STA MLDs with low latency traffic, legacy stations (e.g STA1 310 and STA2 311) without low latency traffic may hold their contention and wait for the next transmission opportunity (TXOP). If two or more STA MLP s concurrently transmit the Defer Signal, they may start a backoff procedure in order to reduce the chance of collision. In example of FIG. 3, STA MLD1 300 and STA MLD2 301 concurrently transmit a Defer Signal 320, 321 and start a backoff procedure. STA MLD1 300 with a random backoff of 4 in a range of 0 to 7 gains TxOP against STA MLD2 301 with a random backoff of 5 and can transmit a PPDU 330 during the gained TxOP 340.

A purpose of the Defer Signal (DSIG), or the like, is to give STA MLDs with low latency traffic a chance to access the medium in an aggressive way, in that the transmission of the DSIG is without any backoff. Any aggressive STA, however, regardless of the type of traffic (low latency or not) it may have, can always transmit the DS at the beginning of a contention period. If there is one such aggressive STA MLD in a BSS, it will always be able to occupy the medium whenever it wants. If there is a group of such aggressive STA MLDs in a BSS, this group of STA MLDs will always have a higher priority to access the medium than the other stations in the BSS. If all the STA MLDs in a BSS are aggressive, then the situation is like traditional channel access, except that the DSIG is always transmitted, unnecessarily, and becomes an additional overhead for any contention period. Therefore, to give STA MLDs with low latency traffic high priority to access the medium by using a DSIG, or the like, while still maintaining a certain degree of fairness among devices in the network and preventing intentionally aggressive STA MLDs from occupying the medium unnecessarily, a flexible control mechanism is desirable.

In a WLAN, it may be desirable that a STA MLD with low latency traffic enjoy higher priority to access the wireless medium than a station without low latency traffic. In representative embodiments in accordance with the present disclosure, a STA MLD with low latency traffic can transmit such traffic with limited or no backoff by first transmitting a signal referred to herein as a Low Latency Traffic Indication (LLTI), LLTI signal, or LLTI frame.

More than one STA MLD may transmit the LLTI concurrently. The LLTI may be transmitted without backoff. After the LLTI is transmitted, STA MLDs which have low latency traffic and/or had transmitted the LLTI may be able to contend for the wireless medium. Limited backoff may entail using a backoff procedure with higher priority, and/or a lower backoff counter (e.g., lower Cmin/Cmax values), etc. After transmission of the LLTI, a STA MLD may perform a backoff procedure, in which it randomly determines a backoff period, senses the wireless medium for any transmission activity thereon, and if in that backoff period does not sense any such activity, may then proceed to transmit its low latency traffic on the wireless medium.

A station (e.g a legacy station) without low latency traffic or which has not transmitted the LLTI may withhold transmission after detecting transmission of an LLTI from other devices. For example, after it detects an LLTI, a STA without low latency traffic may defer its channel access.

The aforementioned procedures may be allowed in a certain period of time or duration, such, as for example, within a TXOP, within a beacon interval, or for any contention period, which may be given dynamically or semi-statically.

FIG. 2B shows an example WLAN 24 including the AP 20, the STA 21 and STA 25 and 26. In the illustrative scenario depicted in FIG. 2B, the AP 20 sends a LLTI element 271 indicating information associated with low latency communication in a transmitted frame 27 such as a beacon frame. Upon receiving frame 27, the STA1 21 may send a responding transmission 28 to the AP 20 indicating LLTI capability information 272 that it allows LLTI transmissions. Upon authorization of LLTI communications by the AP 20, the STA1 21 may then broadcast an LLTI frame 29 to all other STAs (i.e., STA3 25, STA4 26) to capture the medium for its low latency data transmission.

STA 21 has transmitted a frame 28 to indicate its need to transmit low latency traffic and to inform non-low-latency transmitting stations or devices 25, 26 to defer transmission of their traffic. Transmission of the LLTI frame 27 is based on an LLTI element 271 received from, for example, AP 20.

In an embodiment, an AP MLD may designate one or more links for transmitting and receiving low latency traffic. An AP MLD may advertise that one or more links may be used for transmitting and receiving low latency traffic as well as the low latency medium access protocol that may be used for the one or more links. In one example, an AP MLD may transmit a Multi-Link element in one or more management frames that it transmits such as probe response, beacon, FILS Discovery frame, association responses, or other management or control frames. The AP MLD may indicate in such management or control frames that one or more links can be used for low latency traffic, or may only be used for low latency traffic. For example, the Multi-Link Control subfield may carry an indication that Traffic Restriction Info may be present in the Multi-Link element, for example in the Common Info field or in the Link Info field. In another example, the Traffic Restriction Info field may be included by default in the Multi-Link element, for example, in the Common Info field or in the Link Info field. In another example, there may be a Traffic Restriction Info element or field included in the Management or control frames that an AP MLD transmit.

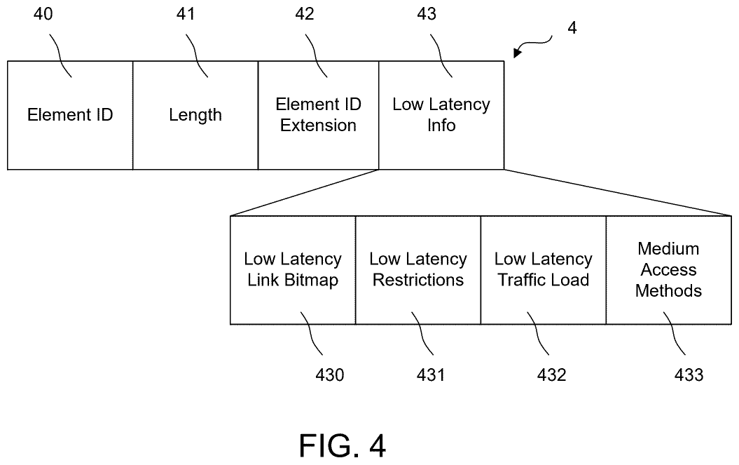

FIG. 4 gives an example of an Information element 4 transmitted by the an AP affiliated with an AP MLD 20, which may be broadcast or to a STA affiliated with a STA MLD, e.g. the STA MLD 21. The Information element may indicate traffic restriction information and may be at least one of a control frame, a management frame, or a data frame or a subframe of a control frame, a management frame, or a data frame. In this example, traffic restriction information comprises a low latency link bitmap subfield that indicates low latency traffic permission associated with the first and the second links.

The Information element 4 includes one or more fields e.g.:
an element ID 40;
a length 41;
an element ID extension 42;
low latency information 43.
a length 41;

Element ID 40 & Element ID Extension 42 fields in combination may indicate that the current Information Element includes the Traffic Restriction Info element.

The length field 41 may indicate the length of the Low Latency info element 43 Info element.

The Low Latency Info field 43 may contain restriction information on traffic information, for example, indication on only allowing low latency traffic on one or more links. The Low Latency Info field 43 may contain one or more of the following subfields:
Low Latency Link Bitmap 430: this subfield may indicate the links on which low latency traffic may be transmitted or received. This subfield may be implemented using a bitmap, for example, of 16 bits. A “0” at a bit position “i” may indicate that low latency traffic is not permitted on link “i+1” or link “i”. A “1” at a bit position “i” may indicate that low latency traffic is permitted on link “i+1” or link “i”. Alternatively, a “0” at a bit position “i” may indicate that none low latency traffic is not permitted on link “i+1” or link “i”. A “1” at a bit position “i” may indicate that none-low latency traffic is permitted on link “i+1” or link “i”. The link may also be identified by number of other means. The one or more links indicated may be one or more links affiliated with an AP MLD or STA MLD.
Low latency restriction 431: this subfield may indicate one or more restrictions for low latency traffic or non-low latency traffic. The value indicated in this subfield may mean that “Low Latency Traffic Only”, “All traffic permitted”, “non-low latency traffic only”, or “A number of traffic types permitted”. When the value indicated is “A number of traffic types permitted”, a field or a bitmap may be included to indicate one or more traffic types that may be permitted, such as “Low Latency Traffic”, “High reliability traffic”, “AC_VI”, “AC_VO”, “AC_BE” and/or “AC BK”.
Low Latency Traffic Load 432: this subfield may be used to indicate the amount of existing low latency load on the indicated link(s) or on the current link. This subfield may indicate the average latency or reliability for low latency traffic on the link(s), or a percentage of tolerable low latency traffic already existing on the link(s), or a number of low latency traffic streams already existing on the link(s).
Medium Access Methods 433: This subfield may be used to indicate the medium access methods used for low latency traffic or non-low latency traffic. Possible values may include “EDCA”, “Low Latency EDCA”, “Defer Signal”, “Deterministic backoff”, “preemption” or other “Low Latency Access”. For Low Latency EDCA, a separate set of EDCA parameters may be announced on one or more links of the AP MLD for low latency traffic.

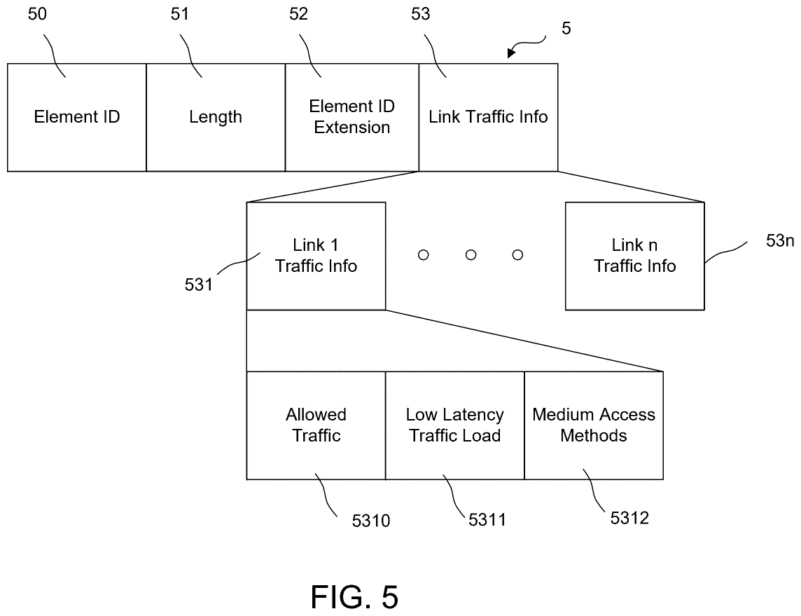

FIG. 5 gives an example of an Information element5 transmitted by an AP affiliated with an AP MLD 20, which may be broadcast or to a STA affiliated with a STA MLD, e.g. the STA MLD 21. The Information element 5 may indicate traffic restriction information and may be at least one of a control frame, a management frame, or a data frame or a subframe of a control frame, a management frame, or a data frame. In this example, the traffic restriction information comprises a first link traffic information and information about one or more second links (e.g. a second link traffic information), the first link traffic information indicating an allowed traffic type on the first link and information about one or more second links indicating an allowed traffic type on one or more second links.

The Information element 5 includes one or more fields e.g.:
an element ID 50;
a length 51;
an element ID extension 52; and
link traffic information 53.

Element ID 50 and Element ID Extension 52 fields in combination may indicate that the current Information Element includes or is the Traffic Restriction Info element within link traffic information 53.

Length 51 field may indicate the length of the Link traffic Info 53 element.

Link Traffic Info 53 field may contain 1 to n Link (n being equal to 1 or a greater number) Traffic Info subfields 531 to 53n, with each subfield corresponding to a link of the AP MLD.

Each Link Traffic Info field 531 to 53nmay indicate traffic information for a link 1 to n, for example, Link 1, or Link n, of the AP MLD that is affiliated with the AP that is transmitting the Traffic Restriction Info element. The Link j (1≤j≤n) Traffic Info field may contain one or more of the following subfields:
Allowed Traffic field 531j may indicate the traffic types that are allowed on this link, including one or more of “Low Latency Traffic”, “High Reliability Traffic”, “AC_VI”, “AC VO”, “AC_BE”, “AC_BK”, etc. In one example, this subfield may be implemented using a bit map, with a “1” or another value indicating a particular type of traffic is allowed on that link while a “0” or another value indicating a particular type of traffic is not allowed on that link. In another example, a “1” or other value may indicate that a particular type of traffic is not allowed on that link while a “0” or another value indicating a particular type of traffic is allowed on that link.
Low Latency Traffic Load subfield 531j may be used to indicate the amount of existing low latency load on the link 1. This subfield may indicate the average latency or reliability for low latency traffic on the link, or a percentage of tolerable low latency traffic already existing on the link, or a number of low latency traffic streams already existing on the link.
Medium Access Methods field 531j may be used to indicate the medium access methods used for low latency traffic or non-low latency traffic. Possible values may include “EDCA”, “Low Latency EDCA”, “Defer Signal”, “Deterministic backoff”, “preemption” or other “Low Latency Access”. For Low Latency EDCA, a separate set of EDCA parameters may be announced on one or more links of the AP MLD for low latency traffic.
   It is understood that in this document, any subfield or field, or element can be designed or implemented using any other subfield or field or elements or part of any management or control frames or data frames, or MAC and PHY headers.

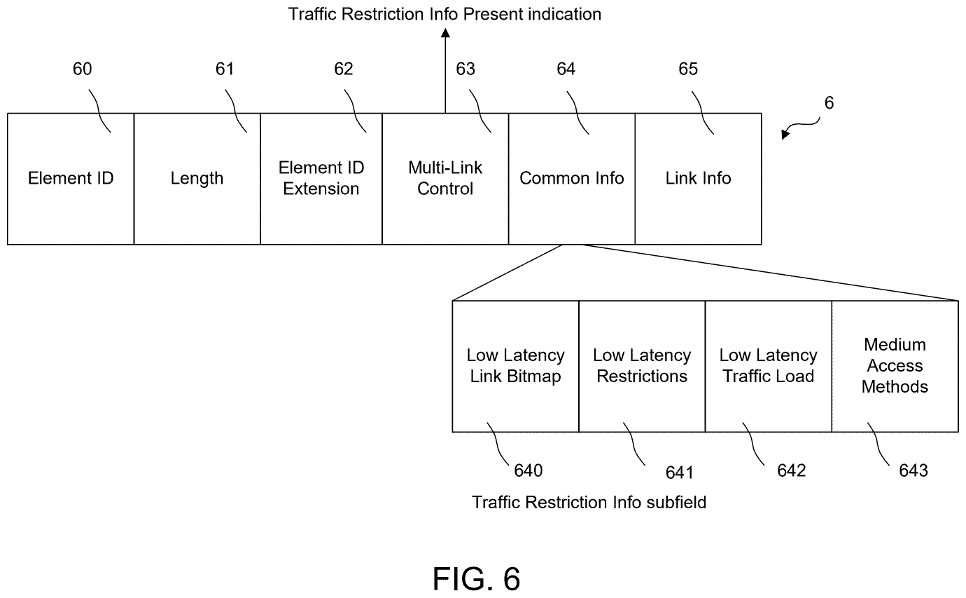

FIG. 6 gives an example of an Information element6 transmitted by an AP affiliated with an AP MLD 20, which may be broadcast or to a STA affiliated with a STA MLD, e.g. the STA MLD 21. The Information element 6 may indicate the traffic restriction information comprises a traffic restriction information presence indicator within a multi-link control field of a multi-link element.

The Information element 6 includes one or more fields e.g.:
an element ID 60;
a length 61;
an element ID extension 62;
a multilink control field 63;
a common control field 64; and
a link information field 65.

In the existing multi-link element, there are a number of fields, including Multi-link control, Common Info and Link Info fields. In one example, the Multi-link control field, in particular, the Presence Bitmap subfield of the Multi-link control field, may carry an indication whether a Traffic Restriction Info may be carried in the Multi-link element, for example, in the Common Info field 64. For example, the multi-link control field may include a boolean variable with a value (e.g. 1) representative of the presence of traffic restriction information and another value (e.g. 0) representative of the absence of traffic restriction information. In another example, the multi-link control field may include more complex values for example, 0 for the absence of traffic restriction information and a type that can take several values if traffic restriction information is present. Such a Traffic Restriction Info, which may contain one or more of the following subfields:
Low Latency Link Bitmap subfield 640 may indicate the links on which low latency traffic may be transmitted or received. This subfield may be implemented using a bitmap, for example, of 16 bits. A “0” at a bit position “i” may indicate that low latency traffic is not permitted on link “i+1” or link “i”. A “1” at a bit position “i” may indicate that low latency traffic is permitted on link “i+1” or link “i”. Alternatively, a “0” at a bit position “i” may indicate that low latency traffic is permitted on link “i+1” or link “i”. A “1” at a bit position “i” may indicate that no low latency traffic is permitted on link “i+1” or link “i”. The link may also be identified by a number of other means. The one or more links indicated may be one or more links affiliated with an AP MLD or STA MLD.
Low latency restriction subfield 641 may indicate one or more restrictions for low latency traffic or non-low latency traffic. The value indicated in this subfield may mean that “Low Latency Traffic Only”, “All traffic permitted”, “non-low latency traffic only”, or “A number of traffic types permitted”. When the value indicated is “A number of traffic types permitted”, a field or a bitmap may be included to indicate one or more traffic types that may be permitted, such as “Low Latency Traffic”, “High reliability traffic”, “AC_VI”, “AC_VO”, “AC_BE” and/or “AC_BK”
Low Latency Traffic Load field 642 may be used to indicate the amount of existing low latency load on the indicated link(s) or on the current link. This subfield may indicate the average latency or reliability for low latency traffic on the link(s), or a percentage of tolerable low latency traffic already existing on the link(s), or a number of low latency traffic streams already existing on the link(s).
Medium Access Methods subfield 643 may be used to indicate the medium access methods used for low latency traffic or non-low latency traffic. Possible values may include “EDCA”, “Low Latency EDCA”, “Defer Signal”, “Deterministic backoff”, “preemption” or other “Low Latency Access”. For Low Latency EDCA, a separate set of EDCA parameters may be announced on one or more links of the AP MLD for low latency traffic.

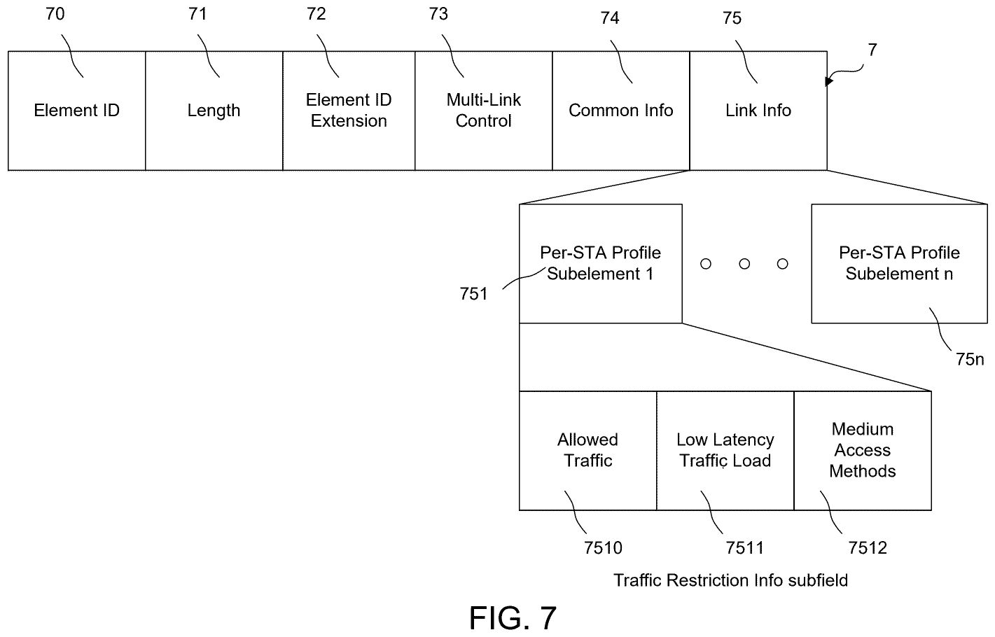

FIG. 7 gives an example of an Information element 7 transmitted by an AP affiliated with the MLD AP 20, which may be broadcast or to a STA affiliated with a STA MLD, e.g. the STA MLD 21. The Information element 7 may indicate the traffic restriction information comprises a first allowed traffic type within a first station sub-element of a multi-link element corresponding to a first STA and one or more second allowed traffic types within one or more second station sub-element of the multi-link element corresponding to a one or more second STA.

The Information element 7 includes one or more fields e.g.:
an element ID 70;
a length 71;
an element ID extension 72;
a multilink control element 73;
a common information field 74; and
a link information field 75.
   The Multi-link element may include in the Link Info field traffic restriction info, for example, traffic restriction info for each of the link that corresponds to a STA j (1≤j ≤n) in a Per-STA Profile subelement 75j (1≤j≤n) in the Link Info field 75. The Per-STA Profile subelement 75j for a link may include a traffic restriction info subfield which may contain one or more of the following subfields:
Allowed Traffic subfield 75j0 may indicate the traffic types that are allowed on this link, including one or more of “Low Latency Traffic”, “High Reliability Traffic”, “AC_VI”, “AC_VO”, “AC_BE”, “AC_BK”, etc. In one example, this subfield may be implemented using a bit map, with a “1” or another value indicating a particular type of traffic is allowed on that link while a “0” or another value indicating a particular type of traffic is not allowed on that link. In another example, a “1” or other value may indicate that a particular type of traffic is not allowed on that link while a “0” or another value indicating a particular type of traffic is allowed on that link.

Low Latency Traffic Load subfield 75j1 may be used to indicate the amount of existing low latency load on the link. This subfield may indicate the average latency or reliability for low latency traffic on the link, or a percentage of tolerable low latency traffic already existing on the link, or a number of low latency traffic streams already existing on the link.
Medium Access Methods subfield 75j2 may be used to indicate the medium access methods used for low latency traffic or non-low latency traffic. Possible values may include “EDCA”, “Low Latency EDCA”, “Defer Signal”, “Deterministic backoff”, “preemption” or other “Low Latency Access”. For Low Latency EDCA, a separate set of EDCA parameters may be announced on one or more links of the AP MLD for low latency traffic.
   Similarly, the traffic restriction info may also be included in Reduced Neighbor Report element or Neighbor Report element.
   The traffic restriction indication and negotiation procedure may be as follows:
A STA may send a probe request frame including a request or indication of request for traffic restriction info to an AP or an AP affiliated with an AP MLD. An STA affiliated with a STA MLD may send a probe request frame or a Multi-Link probe request including a request or indication of request for traffic restriction info to an AP or an AP affiliated with an AP MLD. A STA affiliated with a STA MLD may send a probe request frame or a Multi-link probe request frame to an AP or an AP affiliated with an AP MLD including a request or indication of request for traffic restriction info to an AP or an AP affiliated with an AP MLD.
An AP or an AP affiliated with an AP MLD may respond to a probe request or a multi-link probe response with a probe response frame. The AP may include traffic restriction info in the probe response frame, which may be in response to the indication for requesting traffic restriction info included in the probe request frame or multi-link probe request frame.
An AP may include in a management, control or other type of frames, such as probe response, beacon, FILS discovery frames, a Traffic Restriction info element, indicating traffic restrictions on the indicated or the current link. For example, the AP may indicate that only Low Latency traffic type is currently supported on the indicated links or on the current link as well as the medium access methods that may be used. In another example, the AP may indicate only Low Latency traffic and AC_VI and AC_VO traffic are supported. The AP may also indicate the current load of Low Latency traffic, such as total amount of low latency traffic on the indicated links or on the current link, or average delay of low latency traffic, or the number of existing number of low latency traffic streams on the indicated links or current link. The AP may indicate that it only accepts association requests from STAs that support
An AP affiliated with an AP MLD may include in a management, control or other type of frames, such as probe response, beacon, FILS discovery frames, a Traffic Restriction info element, or traffic restriction information in another element, such as in the Multi-link element, indicating traffic restrictions on one or more indicated links as well as the medium access methods that may be used for the one or more links. For example, the AP may indicate that only Low Latency traffic type is currently supported on the indicated links or on the current link, for example, Link1 of the AP MLD, while all types of traffic can be supported in link 2 of the AP MLD. In another example, the AP may indicate only Low Latency traffic and AC_VI and AC_VO traffic are supported on Link 1 while AC_BE and AC_BK traffic may be supported on Link 2. The AP affiliated with an AP MLD may also indicate the current load of Low Latency traffic, such as total amount of low latency traffic on the indicated links of the AP MLD or on the current link, or average delay of low latency traffic, or the number of existing number of low latency traffic streams on the indicated links or current link. The medium access methods that may used may include EDCA, low latency EDCA, Defer Signal, Deterministic Backoff, or low latency access.
A STA, which may be affiliated with a STA MLD, may receive traffic restriction info from an AP, which may be affiliated with an AP MLD. If the STA or STA MLD supports traffic restriction, it may further evaluate whether the AP or its affiliated AP MLD is sufficient to support its needs. If the STA or STA MLD may transmit or receive low latency traffic, it may evaluate the low latency traffic load on the indicated links to see whether the link has sufficient low latency traffic performance to support its needs. If the STA or its affiliated STA MLD selects the AP or AP MLD for association, it may send an association request to the AP, which may be affiliated with an AP MLD. The association request frame may contain a Traffic Restriction element indicating that the transmitting STA or affiliated STA MLD is capable to supporting traffic restriction. In another example, the association request frame may contain a multi-link element which contains traffic restriction info, which may indicate the traffic restriction capability of the STA or the STA MLD. The traffic restriction info may be contained in the common info field or in the per-STA profile subfield in the Link Info field, with detailed information on planned traffic to be send on each of the link associated with the transmitting STA or one or more STAs that are affiliated with the STA MLD. For example, the STA or STA affiliated with AP MLD may indicate that it may support to transmit or receive only Low Latency traffic and AC_VI and AC_VO traffic are supported on Link 1 while it may support to transmit all types of traffic on Link 2, which may be the same as or different than announced by the AP or the AP affiliated with the AP MLD. The STA or STA affiliated with a STA MLD may also indicate the medium access methods that it may support, which may include EDCA, low latency EDCA, Defer Signal, Deterministic Backoff, or low latency access, etc.
The AP or AP affiliated with the AP MLD that received the association request frame may respond with an association response frame that may also contain a traffic restriction info, which may be contained in a Traffic Restriction element or in a Multi-link element, if the AP or AP affiliated with the AP MLD may accept the association request. The Traffic Restriction element or Multi-link element in the association response frame may indicate to the STA or the STA MLD affiliated with the STA which type of traffic may be transmitted or received on one or more indicated links as well as the Medium Access methods that should be used on the indicated links. For example, the AP or AP affiliated with the AP MLD may indicate that it may support to transmit or receive only Low Latency traffic and AC_VI and AC_VO traffic are supported on Link 1 while it may support to transmit all types of traffic on Link 2, which may be the same as or different than indicated by the STA or by the STA affiliated with the STA MLD in the association request frame. The medium access methods that may used may include EDCA, low latency EDCA, Defer Signal, Deterministic Backoff, or low latency access.
The AP or AP affiliated with the AP MLD that received the association request frame may reject the association request by the STA or a STA affiliated with the STA MLD if the STA or the STA MLD does not support traffic restrictions or the medium access methods required by the AP or AP MLD. The AP or AP affiliated with the AP MLD may use a Reason_Code Traffic_Restriction_Not_Supported and/or Medium_Access_Method_Not_Supported in the association response frame.
When an AP or AP MLD may change its traffic restrictions for its current or one or more links, the AP or APs affiliated with the AP MLD may include a Traffic Restriction element or Reconfiguration Multi-Link element in management, control or other types of traffic the AP or APs transmit, such as in beacons, probe responses, FILS Discovery frames, or Traffic Restriction Action frames, or Operation Mode Change Notification action frames. The Traffic Restriction element or Reconfiguration Multi-Link element may contain the up to date traffic restriction info on the current link or on one or more indicated links as well as medium access methods used. On the one or more indicated links affiliated with the AP MLD where there is new traffic restrictions, STAs or STAs affiliated with the STA MLD that do not support traffic restrictions may be notified of the new configuration, and if they are not able to support traffic restrictions and/or medium access methods, these STAs may be disassociated from the BSS operating on the one or more links, using a Reason_Code Traffic_Restriction_Not_Supported and/or Medium_Access_Method_Not_Supported. The frames transmitted by the AP or APs affiliated with AP MLD may include Reduced Neighbor Report element or Neighbor Report element that contain information of one or more APs that may be affiliated with the same ESS or AP MLD that do not have traffic restrictions. In another example, the Reduced Neighbor Report element or Neighbor Report element may contain information whether the AP described has traffic restrictions. Additionally, or alternatively, the frames transmitted by the AP or AP affiliated with the AP MLD may indicate that the BSSs operating on the indicated links may end and restart with new traffic restriction rules.
When an AP or AP MLD may change its traffic restrictions for its current or one or more links, the AP or APs affiliated with the AP MLD may include a Traffic Restriction element or Reconfiguration Multi-Link element in management, control or other types of traffic the AP or APs transmit, such as in beacons, probe responses, FILS Discovery frames, or Traffic Restriction Action frames, or Operation Mode Change Notification action frames. If the current or one or more indicated links that currently have traffic restriction rules will no longer have any traffic restrictions applied to the links, the Traffic Restriction element may no longer be present in the frames being transmitted or the Traffic Restriction element may indicate that all traffic is allowed. In another example, a Reconfiguration Multi-Link element may contain the up to date traffic restriction info on the current link or on one or more indicated links, indicating that all traffic restrictions is removed or all traffic is allowed on the one or more links.

While this disclosure refers to “low latency traffic,” the methods and apparatuses disclosed herein are not limited to low latency traffic, but may also be implemented for other types of high priority traffic, traffic for which it may be necessary or desirable to provide high priority transmission, or transmission of a higher priority than non-high priority traffic. As such for example, an indication such as the LLTI described above that can be used for high priority traffic may be referred to as a high priority traffic indication (HPTI) or an indication of high priority traffic, containing some or all of the same information or equivalents thereof as the LLTI.

Various numeric values are used in the present disclosure. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc. Use of such terms does not imply an ordering to the modified operations unless specifically required. So, in this example, a first operation need not be performed before a second operation, and may occur, for example, before, during, or in an overlapping time period with the second operation.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information may include one or more of, for example, estimating the information, calculating the information, predicting the information, or retrieving the information from memory.

Further, this disclosure may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

Although the features and elements of the present invention are described in the preferred embodiments in particular combinations, each feature or element can be used alone without the other features and elements of the preferred embodiments or in various combinations with or without other features and elements of the present invention. Although the solutions described herein consider 802.11 specific protocols, it is understood that the solutions described herein are not restricted to this specific implementation and are applicable to other wireless systems as well.

Although SIFS may be used to indicate various inter frame spacing in the examples of the designs and procedures, all other inter frame spacing such as RIFS, AIFS, DIFS or other agreed time interval could be applied in the same solutions. A Long Training Field (LTF) may be any type of predefined sequences that are known at both transmitter and receiver sides.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and a memory, the circuitry being operable (e.g., configured) to process the disclosed method, with a computer program product comprising program code instructions and with a non-transitory computer-readable storage medium storing program instructions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU) or STA MLD; (ii) any of a number of embodiments of a WTRU STA MLD; (iii) a wireless-capable and/or wired-capable (e.g., tetherable) device configured with, inter alia, some or all structures and functionality of a WTRU or STA MLD; (iii) a wireless-capable and/or wired-capable device configured with less than all structures and functionality of a WTRU or STA MLD; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A station (STA) multi-link device (MLD) comprising:
a processor configured to operate a first station (STA) affiliated with the STA MLD and a second STA affiliated with the STA MLD;
a receiver, coupled to the processor, configured to receive, by the first STA from a first access point (AP) affiliated with an AP MLD, on a first wireless link, a frame indicating traffic restriction information associated with the first wireless link and a second wireless link, wherein the second wireless link is configured for communication between the second STA and a second AP affiliated with the AP MLD; and
a transmitter, coupled to the processor, configured to transmit data having a low latency requirement on at least one or more of the first and the second wireless links based on the received traffic restriction information.

2. The STA MLD of claim 1, wherein low latency data has a lower latency requirement relative to other data traffic.

3. The STA MLD of claim 1, wherein the frame is at least one of a control frame, a management frame, or a data frame.

4. The STA-MLD of claim 1, wherein the traffic restriction information comprises a low latency link bitmap subfield that indicates low latency traffic permission associated with the first and the second wireless links.

5. The STA MLD of claim 1, wherein the traffic restriction information comprises a first link traffic information and a second link traffic information, the first link traffic information indicating an allowed traffic type on the first wireless link and the second link traffic information indicating an allowed traffic type on the second wireless link.

6. The STA MLD of claim 1, wherein the traffic restriction information comprises a traffic restriction information presence indicator within a multi-link control field of a multi-link element.

7. The STA MLD of claim 1, wherein the traffic restriction information comprises a first allowed traffic type within a first station sub-element of a multi-link element corresponding to the first STA and a second allowed traffic type within a second station sub-element of the multi-link element corresponding to the second STA.

8. A method for use in a station (STA) multi-link device (MLD), the method comprising:
receiving, by a first STA affiliated with the STA MLD from a first access point (AP) affiliated with an AP MLD, on a first wireless link, a frame indicating traffic restriction information associated the first wireless link and a second wireless link, wherein the second wireless link is configured for communication between a second STA affiliated with the STA MLD and a second AP affiliated with the AP MLD; and
transmitting data having a low latency requirement on at least one or more of the first and the second wireless links based on the received traffic restriction information.

9. The method of claim 8, wherein the traffic restriction information comprises a low latency link bitmap subfield that indicates low latency traffic permission associated with the first and the second wireless links.

10. The method of claim 8, wherein the traffic restriction information comprises a first link traffic information and a second link traffic information, the first link traffic information indicating an allowed traffic type on the first wireless link and the second link traffic information indicating an allowed traffic type on the second wireless link.

11. The method of claim 8, wherein the traffic restriction information comprises a traffic restriction information presence indicator within a multi-link control field of a multi-link element.

12. The method of claim 8, wherein the traffic restriction information comprises a first allowed traffic type within a first station sub-element of a multi-link element corresponding to the first STA and a second allowed traffic type within a second station sub-element of the multi-link element corresponding to the second STA.

13. An access point (AP) multi-link device (MLD) comprising:
a processor configured to operate a first AP affiliated with the AP MLD and a second AP affiliated with the AP MLD;
a transmitter, coupled to the processor, configured to transmit, by the first AP to a first station (STA) affiliated with a STA MLD, on a first wireless link, a frame indicating traffic restriction information associated the first wireless link and a second wireless link, wherein the second wireless link is configured for communication between a second STA affiliated with the STA MLD and the second AP; and
a receiver, coupled to the processor, configured to receive data having a low latency requirement on at least one or more of the first and the second wireless links based on the received traffic restriction information.

14. The AP MLD of claim 13, wherein the frame is at least one of a control frame, a management frame, or a data frame.

15. The AP MLD of claim 13, wherein the traffic restriction information comprises a low latency link bitmap subfield that indicates low latency traffic permission associated with the first and the second wireless links.

16. The AP MLD of claim 13, wherein the traffic restriction information comprises a first link traffic information and a second link traffic information, the first link traffic information indicating an allowed traffic type on the first wireless link and the second link traffic information indicating an allowed traffic type on the second wireless link.

17. The AP MLD of claim 13, wherein the traffic restriction information comprises a traffic restriction information presence indicator within a multi-link control field of a multi-link element.

18. The AP MLD of claim 13, wherein the traffic restriction information comprises a first allowed traffic type within a first station sub-element of a multi-link element corresponding to the first STA and a second allowed traffic type within a second station sub-element of the multi-link element corresponding to the second STA.

19. A method for use in an access point (AP) multi-link device (MLD), the method comprising:
transmitting, by a first AP affiliated with the AP MLD to a first station (STA) affiliated with a STA MLD, on a first wireless link, a frame indicating traffic restriction information associated the first wireless link and a second wireless link, wherein the second wireless link is configured for communication between a second STA affiliated with the STA MLD and a second AP affiliated with the AP MLD; and
receiving data having a low latency requirement relative to other data traffic on at least one or more of the first and the second wireless links based on the received traffic restriction information.

20. The method of claim 19, wherein the frame is at least one of a control frame, a management frame, or a data frame.
